(19) United States
(12) Patent Application Publication
(10) Pub. No.: US 2011/0157249 A1
(43) Pub. Date: Jun. 30, 2011

(54) REFERENCE VOLTAGE GENERATING CIRCUIT AND METHOD FOR GENERATING GAMMA REFERENCE VOLTAGE

(76) Inventor: Seung Nam PARK, Seoul (KR)

(21) Appl. No.: 12/969,761

(22) Filed: Dec. 16, 2010

(30) Foreign Application Priority Data
Dec. 28, 2009 (KR) 10-2009-0131514

(51) Int. Cl. G09G 5/10

(52) U.S. Cl. 345/690; 345/212

(57) ABSTRACT

A reference voltage generating circuit includes a voltage divider, color signal selectors, voltage selectors, voltage drivers and an output driver. The voltage divider outputs first to N-th divided voltages using first and second reference voltages. Each color signal selector generates a divided voltage selection signal for one of RGB color signals. Each voltage selector selects and outputs one of the first to N-th divided voltages output from the voltage divider as a tap voltage for one of the RGB color signals based on the divided voltage selection signal generated by the corresponding color signal selector. Each voltage driver retains the tap voltage output from the corresponding voltage selector and outputs the retained voltage for one of the RGB color signals. The output driver finally outputs gamma reference voltages for one of the RGB color signals using the retained tap voltages output from the voltage drivers.

The present application claims priority under 35 U.S.C. §119 to Korean Patent Application No. 10-2009-0131514 (filed on Dec. 28, 2009), which is hereby incorporated by reference in its entirety.

### BACKGROUND

Generally, unlike a thin-film transistor LCD (TFT-LCD) which utilizes color filters, an organic LED device has elements which respectively implement three primary colors of red (R), green (G), and blue (B) without use of a color filter. In an organic LED, an organic material is used which outputs a color with different luminance depending on a voltage to be applied thereto, producing each color of RGB. Thus, a screen can be displayed without using a backlight and color filters.

An organic material which produces each color of RGB has a difference in characteristics depending on a voltage to be applied thereto. The organic material is different in luminance and efficiency depending on the voltage level. The organic material which produces each color of R, G, and B is different from each other in luminance characteristics, depending on the voltage level to be applied thereto. For this reason, if common gamma reference voltages GMA1 to GMAn are used for all of R, G, B colors, the optimum luminance characteristics of organic light-emitting elements which respectively produce RGB may not be obtained, and thus, the driver for driving the organic light-emitting elements applies different gamma reference voltages to the light-emitting elements which respectively produce R, G, and B based on their color.

FIG. 1 is a block diagram illustrating a driving circuit for driving organic light-emitting elements in the prior art. As illustrated in FIG. 1, the driving circuit includes three reference voltage generators 1 generating gamma reference voltages R-GMA1 to R-GMAn, G-GMA1 to G-GMAn, and B-GMA1 to B-GMAn, and driver 2 applied with gamma reference voltages R-GMA1 to R-GMAn, G-GMA1 to G-GMAn, and B-GMA1 to B-GMAn from reference voltage generators 1, applied with external power supply voltages RVDD, GVDD, and BVDD, and applied with ground voltage GND. Driver 2 applies currents based on gamma reference voltages R-GMA1 to R-GMAn, G-GMA1 to G-GMAn, and B-GMA1 to B-GMAn to the organic light-emitting elements in accordance with data signals to display a screen.

FIG. 2 is a detailed circuit diagram of the driving circuit illustrated in FIG. 1. As illustrated in FIG. 2, the driving circuit includes address shift register 10 which is applied with control signal CONTROL and clock signal CLK to store addresses and sequentially generate address signals, input register 20 which is applied with and stores image data R-DATA, G-DATA, and B-DATA for RGB, and is applied with the address signals from address shift register 10. Storage register 30 stores and sequentially outputs image data R-DATA, G-DATA, B-DATA and the address signals input through input register 20. Digital/analog converter 40 is applied with output of storage register 30, power supply voltages RVDD, GVDD, and BVDD for RGB, and plurality of gamma reference voltages R-GMA1 to R-GMAn, G-GMA1 to G-GMAn, and B-GMA1 to B-GMAn for RGB, and outputs analog image data based on the addresses. Driver 50 is applied with the analog image data and outputs driving voltages.

As illustrated in FIGS. 1 and 2, different gamma reference voltages are applied for one of RGB colors. The pixels are driven using the gamma reference voltages.

In accordance with the prior art, in order to generate different gamma reference voltages for each of RGB, at least three reference voltage generating circuits have to be provided for three colors of RGB.

FIG. 3 is a block diagram showing a reference voltage generating circuit for generating gamma reference voltages for an R (Red) color signal. The reference voltage generating circuit for an R color signal includes voltage divider 60, a plurality of voltage selectors 70, a plurality of voltage drivers 80, and reference voltage output driver 90. Voltage divider 60 divides the reference voltages across both ends of a plurality of serial resistors using the serial resistors, and outputs various types of divided voltages. Voltage selectors 70 are input with divided voltage selection signals SEL_A, SEL_B, . . . , SEL_K, and SEL_L for generating the gamma reference voltages R-GMA<1˜N> together with the divided voltages. Each voltage selector 70 selects and outputs a single tab voltage O1_A, O1_B, . . . , O1_K, or O1_L based on the divided voltage selection signal SEL_A, SEL_B, . . . , SEL_K, or SEL_L. Each voltage driver 80 acts as a buffer which retains the first tab voltage O1_A, O1_B, . . . , O1_K, or O1_L selected by the corresponding voltage selector 70 at a constant voltage, outputs a second tab voltage O2_A, O2_B, . . . , O2_K, or O2_L at a predetermined magnitude to the reference voltage output driver 90. Reference voltage output driver 90 outputs the gamma reference voltages R-GMA<1˜N> for R color signal which are applied to driver 2 illustrated in FIG. 1.

In the prior art, however, three reference voltage generating circuits illustrated in FIG. 3 which respectively generate the gamma reference voltages for RGB have to be provided so as to apply different gamma reference voltages for RGB as mentioned on the above. The reference voltage generating circuit includes resistor arrays which internally generate reference tab voltages, buffer amplifiers which buffer the reference tab voltages, and other resistor arrays which output gamma voltages between buffers. Such a configuration has to be provided for each color of RGB, thereby imposing a burden from the viewpoint of the size of the driving IC. Since three reference voltage generating circuits have to be provided for three color of RGB, reference voltage error of each color of RGB may occur more frequently from the viewpoint of process distribution or design.

Such errors are contrary to the initial purpose for improving image quality through driving with different voltages for each color of RGB. Accordingly, there is a demand for a circuit which can compensate for errors for RGB. There is also a problem in that three reference voltage generating circuits are provided, causing power consumption in the driver 2 three or more times.

The layout structure in circuit design will be described with reference to FIG. 1. Different gamma reference voltages have to be applied to driver 2 in a state of being arranged in parallel to the Y axis (that is, height) of the driver IC. Accordingly, it is disadvantageous from the viewpoint of the size of metal lines to be provided, and there is an adverse effect due to parasitic capacitance between metal lines. If the number of metal lines required for each color of RGB is 256, the total number of metal lines for driving is 768 (256×3). This causes a great burden on the size of the Y axis (that is, height) of the driver IC.

### SUMMARY

Embodiments relate to a semiconductor technology, and in particular, to a reference voltage generating circuit and a method for generating the gamma reference voltages for RGB (Red/Green/Blue).

Embodiments relate to a reference voltage generating circuit which generates gamma reference voltages for RGB with a single structure, achieving reduction in the size of a driving IC and power consumption.

In accordance with embodiments, a reference voltage generating circuit is provided including: a voltage divider which outputs first to N-th divided voltages using first and second reference voltages; a plurality of color signal selectors, each generating a divided voltage selection signal for one of RGB color signals; a plurality of voltage selectors, each selecting and outputting one of the first to N-th divided voltages output from the voltage divider as a tap voltage for one of the RGB color signals based on the divided voltage selection signal generated by the corresponding color signal selector; a plurality of voltage drivers, each retaining the tap voltage output from the corresponding voltage selector and outputting the retained voltage for one of the RGB color signals; and an output driver which finally outputs gamma reference voltages for one of the RGB color signals using the retained tap voltages output from the plurality of the voltage drivers.

Preferably, each of the color signal selectors is input with a RGB selection signal for selecting a driving time of the gamma reference voltages for one of the RGB color signals, and generates the divided voltage selection signal based on the RGB selection signal.

Preferably, when the divided voltage selection signal generated by each of the color signal selectors is the divided voltage selection signal for the R (Red) color signal from among the RGB color signals, the gamma reference voltages output from the output driver are gamma reference voltages for the R (Red) color signal.

Preferably, when the divided voltage selection signal generated by each of the color signal selectors is the divided voltage selection signal for the G (Green) color signal from among the RGB color signals, the gamma reference voltages outputted from the output driver are gamma reference voltages for the G (Green) color signal.

Preferably, when the divided voltage selection signal generated by each of the color signal selectors is the divided voltage selection signal for the B (Blue) color signal from among the RGB color signals, the gamma reference voltages outputted from the output driver are gamma reference voltages for the B (Blue) color signal.

Preferably, the reference voltage generation circuit is driven with 8-bit RGB.

In accordance with embodiments, a reference voltage generating circuit is provided including: a voltage divider which outputs first to N-th divided voltages using first and second reference voltages; a plurality of color signal and voltage selectors, each selecting and outputting one of the first to N-th divided voltages output from the voltage divider as a tap voltage for one of the RGB color signals based on a RGB selection signal for selecting a driving time of gamma reference voltages for one of the RGB color signals; a plurality of voltage drivers, each retaining the tap voltage output from the corresponding color signal and voltage selector and outputting the retained tap voltage for one of the RGB color signals; and an output driver which finally outputs the gamma reference voltages for one of the RGB color signals using the retained tap voltages output from the plurality of voltage drivers.

Preferably, the reference voltage generation circuit is driven with 8-bit RGB.

In accordance embodiments, a method for generating gamma reference voltages for RGB color signals to drive a display device is provided, the method including: outputting first to N-th divided voltages using first and second reference voltages; receiving a RGB selection signal and selectively outputting divided voltage selection signals for one of RGB color signals based on the RGB selection signal; outputting the first to N-th divided voltages selectively as tab voltages for one of the RGB color signals based on the divided voltage selection signals; retaining the tab voltages and outputting the retained tab voltages for one of the RGB color signals; and then finally outputting gamma reference voltages for one of the RGB color signals using the retained voltages.

Preferably, gamma reference voltages for the R (Red) color signal are outputted during a first driving time, gamma reference voltages for the G (Green) color signal are outputted during a second driving time, and gamma reference voltages for the B (Blue) color signal are outputted during a third driving time.

Preferably, the RGB selection signal received during the first driving time is a selection signal which means selection of the R (Red) color signal.

Preferably, the RGB selection signal received during the second driving time is a selection signal which means selection of the G (Green) color signal.

Preferably, the RGB selection signal received during the third driving time is a selection signal which means selection of the B (Blue) color signal.

Preferably, the divided voltage selection signals outputted during the first driving time are divided voltage selection signals for the R (Red) color signal.

Preferably, the divided voltage selection signals outputted during the second driving time are divided voltage selection signals for the G (Green) color signal.

Preferably, the divided voltage selection signals outputted during the third driving time are divided voltage selection signals for the B (Blue) color signal.

In accordance with embodiments, a single reference voltage generating circuit provides different gamma reference voltages for respective colors of RGB. Thus, power consumption drained by the reference voltage generating circuit is reduced, and the total size of a driving IC is reduced, having an advantage from the viewpoint of the size. It is also advantageous from the viewpoint of the size metal lines to be provided, and the reduction in the number of metal lines allows reduction in parasitic capacitance between metal lines. This also allows reduction in gamma settling time. The gamma reference voltages for RGB are generated by a single reference voltage generating circuit, such that there is little deterioration on image quality due to reference voltage errors compared to a case where a plurality of reference voltage generating circuits are used.

### DRAWINGS

FIGS. 1 to 3 is a block diagram illustrating a driving circuit for driving an organic light-emitting element, a detailed circuit diagram of the driving circuit of FIG. 1 and diagram of a reference voltage generating circuit for an R color signal.

FIG. 4 is a diagram illustrating a single reference voltage generating circuit in accordance with embodiments.

FIG. 5 is a block diagram illustrating the configuration of a single reference voltage generating circuit in accordance with embodiments.

FIG. 6 is a block diagram illustrating the configuration of a single reference voltage generating circuit in accordance with embodiments.

FIG. 7 is a timing chart illustrating a final output voltage when the reference voltage generating circuit shown in FIGS. 5 and 6 is used.

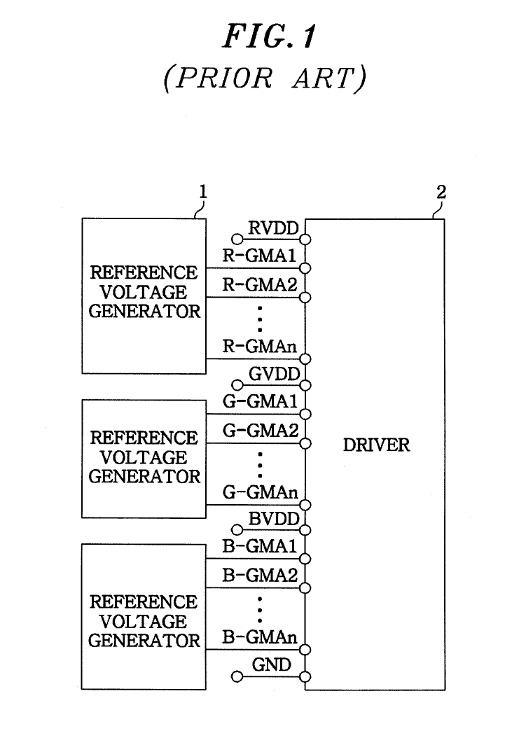

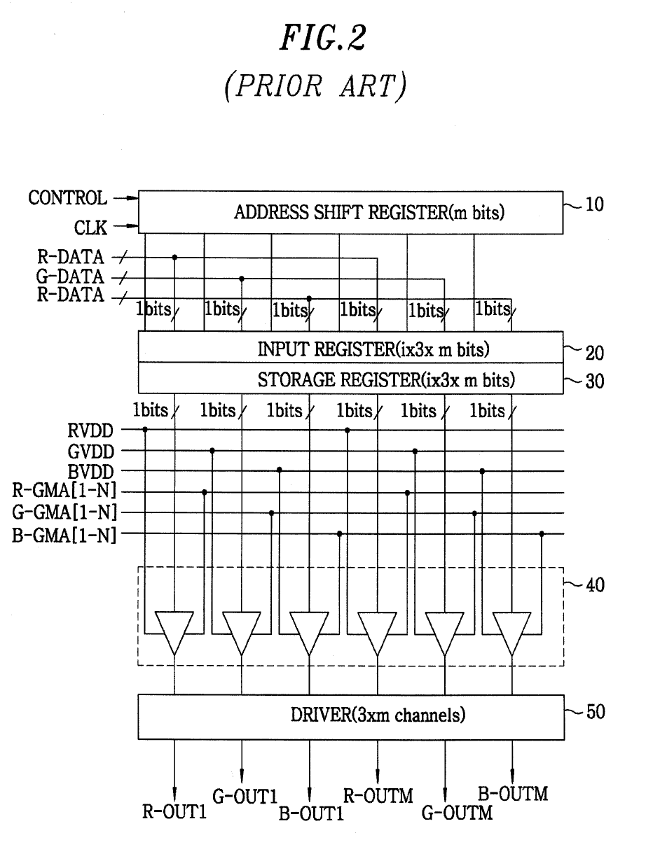

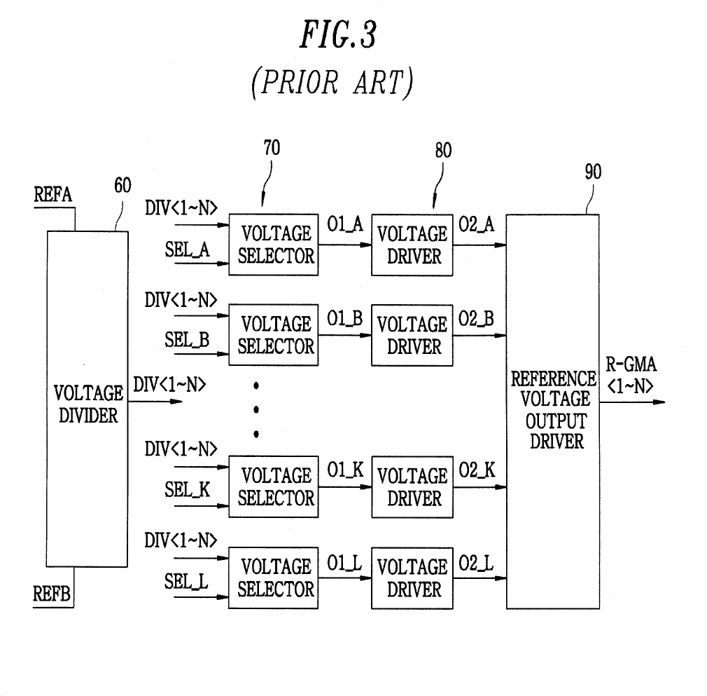

### DESCRIPTION

Hereinafter, exemplary embodiments of a reference voltage generating circuit in accordance with embodiments will be described in detail.

A reference voltage generating circuit in accordance with embodiments is a circuit for driving a Source Shared Display (SSD) type panel.

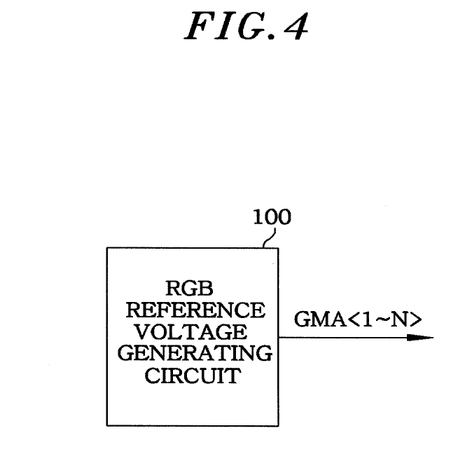

FIG. 4 is a diagram showing a single reference voltage generating circuit in accordance with embodiments. Embodiments provides a single reference voltage generating circuit 100 adapted to selectively generating gamma reference voltages for all of RGB color signals.

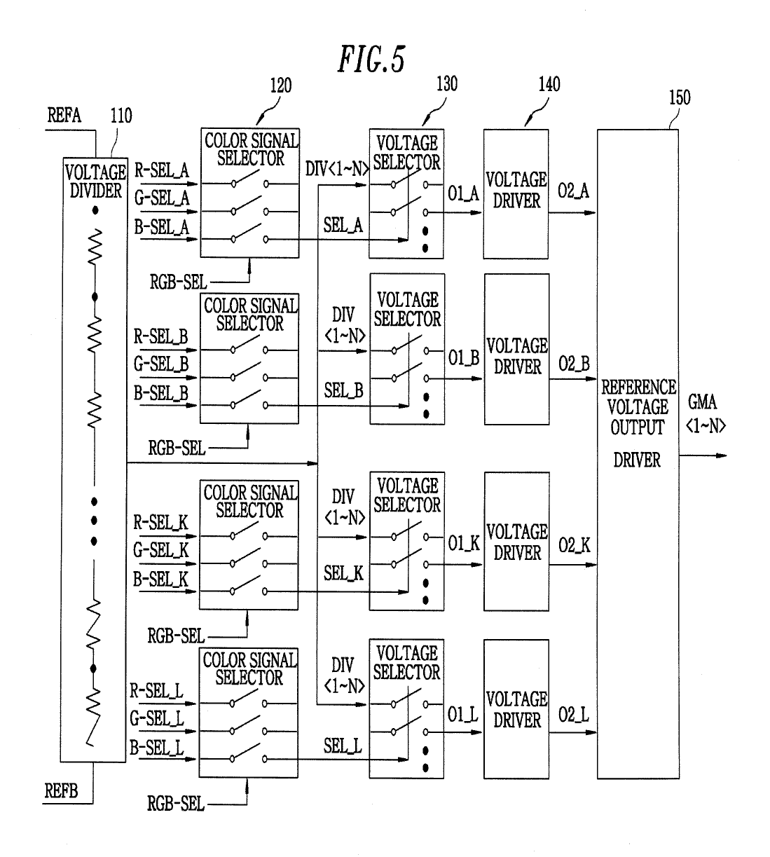

FIG. 5 is a block diagram illustrating the configuration of a single reference voltage generating circuit in accordance with embodiments.

A reference voltage generating circuit in accordance with embodiments includes voltage divider 110, a plurality of color signal selectors 120, a plurality of voltage selectors 130, a plurality of voltage drivers 140, and reference voltage output driver 150.

In generating and outputting gamma reference voltages for RGB signals, the reference voltage generating circuit sets a first driving time during which the gamma reference voltages for the R (Red) color signal are output, a second driving time during which the gamma reference voltages for the G (Green) color signal are output, and a third driving time during which the gamma reference voltages for the B (Blue) color signal are output, and outputs the gamma reference voltages for each color signal on the basis of time. Different driving times are set by a RGB selection signal RGB_SEL. The RGB selection signal RGB_SEL is input to each color signal selector 120.

Voltage divider 110 outputs first to N-th divided voltages DIV<1˜N> using first and second reference voltages REFA and REFB applied from the outside or generated internally and a plurality of serial resistors. Each color signal selector 120 receives divided voltage selection signals R-SEL, G-SEL, and B-SEL suitable for the respective RGB color signals, and outputs one of the divided voltage selection signals R-SEL, G-SEL, and B-SEL as a divided voltage selection signal SEL_A, SEL_B, . . . , SEL_K, or SEL_L based on the RGB selection signal RGB-SEL. Meaning, the RGB selection signal RGB-SEL is used to select the driving time of the gamma reference voltages for one of the RGB color signals. Thus, the RGB selection signal RGB-SEL determines the first to third driving times.

For example, in the case of the driving time (first driving time) of the gamma reference voltages for the R (Red) color signal from among the RGB color signals, color signal selector 120 receives a RGB selection signal RGB-SEL which means selection of the R (Red) color signal. Then, color signal selector 120 outputs a divided voltage selection signal suitable for the R (Red) color signal. Thus, the gamma reference voltages which are finally output from reference voltage output driver 150 are the gamma reference voltages for the R (Red) color signal.

In the case of the driving time (second driving time) of the gamma reference voltages for the G (Green) color signal from among the RGB color signals, color signal selector 120 receives a RGB selection signal RGB-SEL which means selection of the G (Green) color signal. Then, color signal selector 120 outputs a divided voltage selection signal suitable for the G (Green) color signal. Thus, the gamma reference voltages which are finally output from reference voltage output driver 150 are the gamma reference voltages for the G (Green) color signal.

In the case of the driving time (third driving time) of the gamma reference voltages for the B (Blue) color signal from among the RGB color signals, color signal selector 120 receives a RGB selection signal RGB-SEL which means selection of the B (Blue) color signal. Then, color signal selector 120 outputs a divided voltage selection signal suitable for the B (Blue) color signal. Thus, the gamma reference voltages which are finally output from reference voltage output driver 150 are the gamma reference voltages for the B (Blue) color signal.

Each of a plurality of voltage selectors 130 selects and outputs one of the first to N-th divided voltages output from voltage divider 110 as a tab voltage O1_A, O1_B, . . . , O1_K, or O1_L for one of the RGB color signals based on the divided voltage selection signal SEL_A, SEL_B, . . . , SEL_K, or SEL_L output from the corresponding color signal selector 120. Each of the plurality of the voltage drivers 140 functions as a buffer which retains the tab voltage O1_A, O1_B, . . . , O1_K, or O1_L output from the corresponding voltage selector 130 at a constant voltage and outputs, at a predetermined magnitude, the retained voltage as a voltage O2_A, O2_B, . . . , O2_K, or O2_L for one determined by the RGB selection signal from among the RGB color signals.

Reference voltage output driver 150 finally outputs the gamma reference voltages for one determined by the RGB selection signal RGB-SEL from among the RGB color signals using the voltages O2_A, O2_B, . . . , O2_K, and O2_L output from the plurality of voltage drivers 140 during the set driving time of the color signal. At this time, when the reference voltage generation circuit is driven with 8-bit RGB, reference voltage output driver 150 may output 256 gamma reference voltages GMA<1˜N> for each color.

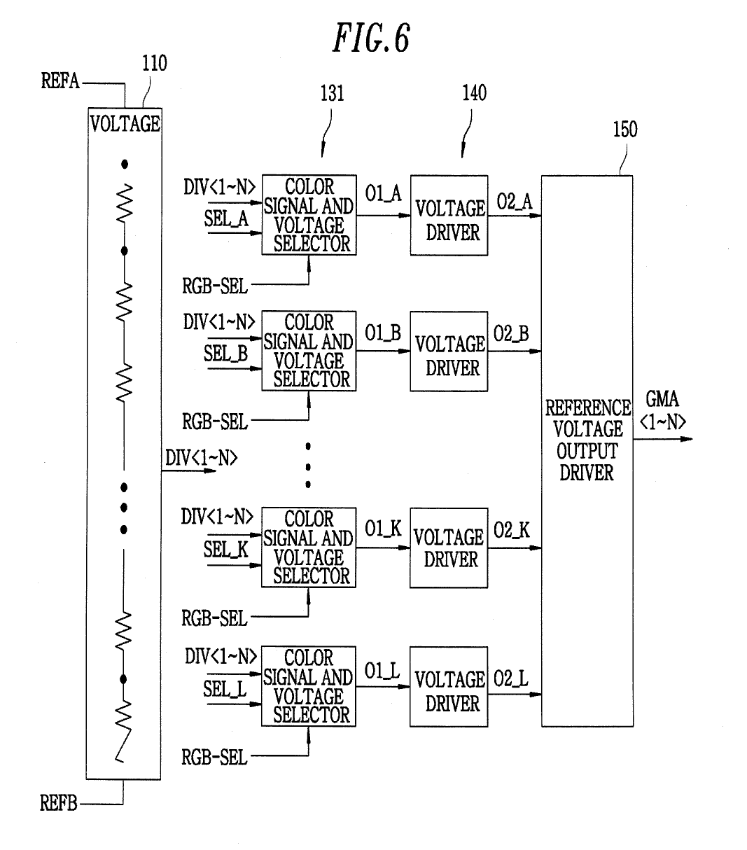

FIG. 6 is a block diagram illustrating a single reference voltage generating circuit in accordance with embodiments. While in case of the reference voltage generating circuit illustrated in FIG. 5, color signal selectors 120 are provided as many as voltage selectors 130, a single color signal and voltage selector 131 is used in the reference voltage generating circuit illustrated in FIG. 6 instead of each color signal selector 120 and the corresponding voltage selector 130 of the reference voltage generating circuit illustrated in FIG. 5.

Description will now be provided as to the circuit operation with reference to FIG. 6. Voltage divider 110 outputs the first to N-th divided voltages DIV<1˜N> using the first and second reference voltages REFA and REFB applied from the outside or generated internally. Each of the plurality of color signal and voltage selectors 131 selects and outputs one of the first to N-th divided voltages output from voltage divider 110 as a tab voltage O1_A, O1_B, . . . , O1_K, or O1_L for one of the RGB color signals based on the RGB selection signal RGB-SEL for selecting the driving time of the gamma reference voltages for one of the RGB color signals and the divided voltage selection signal SEL_A, SEL_B, . . . , SEL_K, or SEL_L. Each of the plurality of voltage drivers 140 retains the tab voltage O1_A, O1_B, . . . , O1_K, or O1_L output from the corresponding color signal and voltage selector 130 at a constant voltage and outputs, at a predetermined magnitude, the retained voltage as a voltage O2_A, O2_B, . . . , O2_K, or O2_L for one determined by the RGB selection signal from among the RGB color signals.

Reference voltage output driver 150 finally outputs the gamma reference voltages for one determined by the RGB selection signal RGB-SEL from among the RGB color signals using the voltages O2_A, O2_B, . . . , O2_K, and O2_L output from the plurality of voltage drivers 140 for the set driving time of the color signal. At this time, when the reference voltage generating circuit is driven with 8-bit RGB, reference voltage output driver 150 outputs 256 gamma reference voltages GMA<1˜N> for each color.

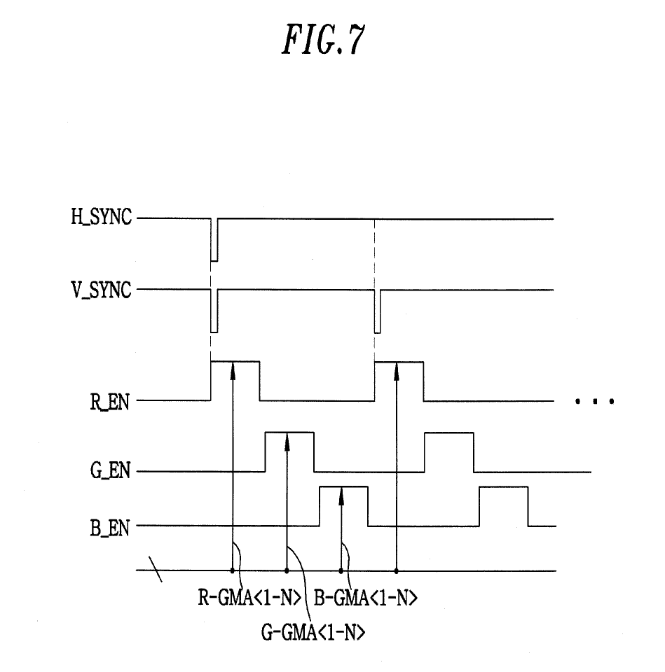

FIG. 7 is a timing chart illustrating final output voltages when the reference voltage generating circuit of FIGS. 5 and 6 is used, i.e., a timing chart showing the final output voltages when a single reference voltage generating circuit is used.

In FIG. 7, V_SYNC is a signal for synchronization of a frame start point. Each frame starts at the falling edge of V_SYNC. H_SYNC is a horizontal line sync signal. Each gate signal is enabled at the falling edge of H_SYNC, and data voltages which will be displayed on each pixel are output and stored in a storage cell in synchronization with the enabled gate signal. At this time, the stored data of each pixel is already stored in an internal latch unit or storage unit, and the output gamma reference voltages GMA<1˜N> are the gamma reference voltages R_GMA<1˜N>, G_GMA<1˜N>, or B_GMA<1˜N> for one of the RGB color signals based on the RGB selection signal for selecting the driving time (first, second, or third driving time) of the gamma reference voltage for one of the RGB color signals and one of enable signals R_EN, G_EN, and B_EN for RGB.

With the reference voltage generating circuit in accordance with embodiments, the reference voltage generating circuit which is driven with 8-bit RGB can selectively output the R (Red) color gamma reference voltages R_GMA<1> to R_GMA<256> in a range of 0.1 V to 4.8 V, the G (Green) color gamma reference voltages G_GMA<1> to G_GMA<256> in a range of 0.092 V to 4.416 V, or the B (Blue) color gamma reference voltages B_GMA<1> to B_GMA<256> in a range of between 0.096 V to 4.608 V for the driving time of the corresponding color.

Although embodiments have been described herein, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. An apparatus comprising:
a voltage divider configured to output first to N-th divided voltages using first and second reference voltages;
a plurality of color signal selectors, each of the color signal selectors configured to generate a divided voltage selection signal for one of RGB (Red, Green, Blue) color signals;
a plurality of voltage selectors, each of the voltage selectors configured to select and output one of the first to N-th divided voltages output from the voltage divider as a tap voltage for one of the RGB color signals based on the divided voltage selection signal generated by a corresponding color signal selector;
a plurality of voltage drivers, each of the voltage drivers configured to retain the tap voltage output from a corresponding voltage selector and output the retained voltage for one of the RGB color signals; and
an output driver configured to finally output gamma reference voltages for one of the RGB color signals using the retained tap voltages output from the plurality of voltage drivers.

2. The apparatus of claim 1, wherein each of the color signal selectors is input with a RGB selection signal for selecting a driving time of the gamma reference voltages for one of the RGB color signals, and generates the divided voltage selection signal based on the RGB selection signal.

3. The apparatus of claim 1, wherein the gamma reference voltages output from the output driver are gamma reference voltages for the R (Red) color signal when the divided voltage selection signal generated by each of the color signal selectors is the divided voltage selection signal for the R (Red) color signal from among the RGB color signals.

4. The apparatus of claim 1, wherein the gamma reference voltages output from the output driver are gamma reference voltages for the G (Green) color signal when the divided voltage selection signal generated by each of the color signal selectors is the divided voltage selection signal for the G (Green) color signal from among the RGB color signals.

5. The apparatus of claim 1, wherein the gamma reference voltages output from the output driver are gamma reference voltages for the B (Blue) color signal when the divided voltage selection signal generated by each of the color signal selectors is the divided voltage selection signal for the B (Blue) color signal from among the RGB color signals.

6. The apparatus of claim 1, wherein the apparatus comprises a reference voltage generating circuit.

7. The apparatus of claim 6, wherein the reference voltage generation circuit is driven with 8-bit RGB.

8. An apparatus comprising:
a voltage divider configured to output first to N-th divided voltages using first and second reference voltages;
a plurality of color signal and voltage selectors, each of the color signal and voltage selectors configured to select and output one of the first to N-th divided voltages output from the voltage divider as a tap voltage for one of the RGB color signals based on a RGB selection signal for selecting a driving time of gamma reference voltages for one of the RGB color signals;
a plurality of voltage drivers, each of the voltage drivers configured to retain the tap voltage output from a corresponding color signal and voltage selector and output the retained tap voltage for one of the RGB color signals; and
an output driver configured to finally output the gamma reference voltages for one of the RGB color signals using the retained tap voltages output from the plurality of voltage drivers.

9. The apparatus of claim 8, wherein the apparatus comprises a reference voltage generating circuit.

10. The apparatus of claim 9, wherein the reference voltage generation circuit is driven with 8-bit RGB.

11. A method for generating gamma reference voltages for RGB color signals to drive a display device, the method comprising:
outputting first to N-th divided voltages using first and second reference voltages;
receiving a RGB selection signal and then selectively outputting divided voltage selection signals for one of RGB color signals based on the RGB selection signal;
outputting the first to N-th divided voltages selectively as tab voltages for one of the RGB color signals based on the divided voltage selection signals;
retaining the tab voltages and outputting the retained tab voltages for one of the RGB color signals; and then
finally outputting gamma reference voltages for one of the RGB color signals using the retained voltages.

12. The method of claim 11, wherein gamma reference voltages for the R (Red) color signal are output during a first driving time, gamma reference voltages for the G (Green) color signal are output during a second driving time, and gamma reference voltages for the B (Blue) color signal are output during a third driving time.

13. The method of claim 12, wherein the RGB selection signal received during the first driving time is a selection signal results in a selection of the R (Red) color signal.

14. The method of claim 13, wherein the divided voltage selection signals output during the first driving time are divided voltage selection signals for the R (Red) color signal.

15. The method of claim 12, wherein the RGB selection signal received during the second driving time is a selection signal results in a selection of the G (Green) color signal.

16. The method of claim 15, wherein the divided voltage selection signals output during the second driving time are divided voltage selection signals for the G (Green) color signal.

17. The method of claim 12, wherein the RGB selection signal received during the third driving time is a selection signal results in a selection of the B (Blue) color signal.

18. The method of claim 17, wherein the divided voltage selection signals output during the third driving time are divided voltage selection signals for the B (Blue) color signal.
